(19) United States
(12) Patent Application Publication
(10) Pub. No.: US 2017/0123886 A1
(43) Pub. Date: May 4, 2017

(54) System and Method for Assessing Degree of Impact of Alerts in an Information Handling System

(71) Applicant: Dell Products, LP, Round Rock, TX (US)

(72) Inventor: Ganesan Vaideeswaran, Bangalore (IN)

(21) Appl. No.: 14/927,231

(22) Filed: Oct. 29, 2015

(51) Int. Cl. G06F 11/07; G06F 11/34

(52) U.S. Cl. CPC G06F 11/0772; G06F 11/3495; G06F 11/0751

(57) ABSTRACT

An information handling system includes a plurality of components, a memory to store a prioritized list of alerts issued in the information handling system, and a system management module. The system management module maintains the prioritized list of alerts, receives an alert indicating an event within the information handling system, determines an overall degree of impact of the alert message on the information handling system, and sorts the alert message within the prioritized list of alerts based on the overall degree of impact of the alert message as compared to an overall degree of impact of each of the alert messages in the prioritized list of alerts

### FIELD OF THE DISCLOSURE

The present disclosure generally relates to information handling systems, and more particularly relates to assessing the degree of impact of alerts in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

A device within an information handling system can generate an alert to indicate that an event, such as a failure, power loss, warning, or the like has happened in the information handling system. The alert can be provided to a management station, which in turn can provide the alert to an operator for resolution of the error or event that caused the alert.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system;

FIG. 2 is a diagram illustrating edge directions for components within the information handling system;

FIG. 3 is a diagram illustrating component type impact weights for each of the components within the information handling system;

FIG. 4 is a diagram illustrating component degree of impact for each of the components within the information handling system;

FIG. 5 is a diagram illustrating an alert graphical user interface displaying alerts generated in the information handling system; and

FIG. 6 is a flow diagram illustrating a method for assessing degree of impact of alerts in the information handling system.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

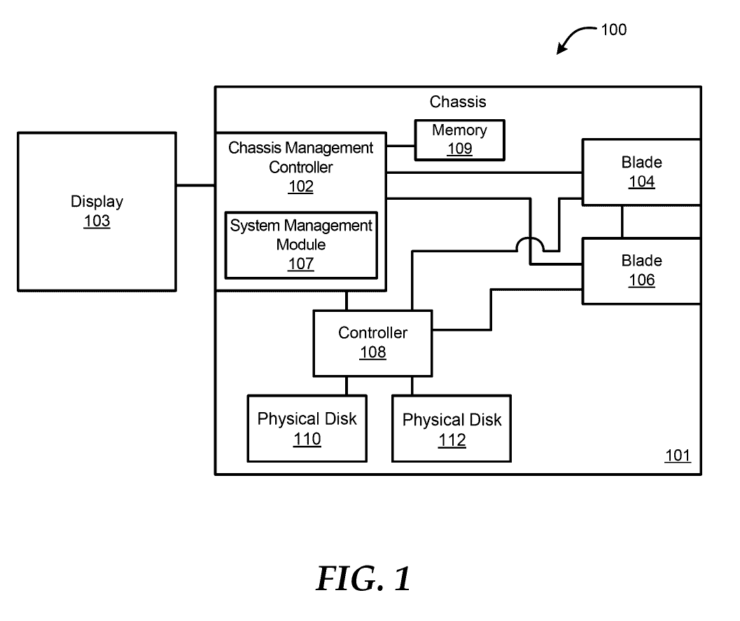

FIG. 1 shows an information handling system 100. In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (such as random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

The information handling system 100 includes a chassis 101, a chassis management controller 102, a display 103, servers or blades 104 and 106, a system management module 107, a controller 108, a memory 109, and physical disk drives 110 and 112. The chassis management controller 102 is in communication with the display 103, with the blades 104 and 106, with the controller 108, and with the memory 109. The controller 108 is in communication with the blades 104 and 106 and with the physical disks 110 and 112. In an embodiment, the controller 108 can be a redundant array of independent disks (RAID) controller, and control the read/write accesses to the physical disks 110 and 112. In this embodiment, the chassis management controller 102 and the blades 104 and 106 can communicate with the physical disks 110 and 112 via the controller 108.

In an embodiment, the blades 104 and 106 can be configured as independent servers or information handling systems that perform operations independent from one another, can be configured a cluster that performs one or more operations using both of the blades as a single information handling system, or the like. In an embodiment, the physical disks 110 and 112 can be assigned or allocated as a single virtual disk that can be utilized by the chassis management controller 102 and the blades 104 and 106 as a storage device.

During operation of the information handling system 100, alerts can be generated for the devices, such as the chassis management controller 102, the blades 104 and 106, the controller 108, and the physical disks 110 and 112, and these alerts can be provided as messages to the system management module 107 of the chassis management controller 102. In an embodiment, the alerts can indicate some event that happened on the device, such as a failure, power loss, or the like. The system management module 107 can receive these alerts and then provide the alerts to an individual or operator of the information handling system 100 via a prioritized list of alerts via the display 103. The operator can continuously monitor the alerts and can perform one or more actions to resolve the alert.

In an embodiment, the devices in the information handling system 100 can produce a large amount of alerts, such that operators may have to prioritize the newly received alerts among a large number of alerts that have already been received. In an embodiment, the alert messages received by the system management module 107 can be prioritized by the severity of alerts. In an embodiment, the prioritized list of alerts can be stored in the memory 109, which can be external of or internal to the chassis management controller 102. The severity of the alerts can be in one of three categories, such as critical, major, or minor. Prioritizing the alerts by the severity of the alert can ensure that the alerts are addressed based on the critical nature of the situation. However, if there are a large number of alerts of same severity, an operator may have to sift through all of the alerts of the same severity to prioritize these alerts within the severity group.

The system management module 107 can use additional information about the device or component that produced the alert to further prioritize the alert among the other alerts with the same severity level. In an embodiment, the system management module 107 can dynamically determine the impact of alert on the information handling system depending on the context of the alert. For example, the system management module 107 can receive a critical alert identifying that physical disk 110 has failed. The system management module 107 can then determine the impact of this alert based on the context of how the physical disk 110 is being utilized in the information handling system 100.

For example, if the physical disk 110 is not assigned to any virtual disk, then the physical disk is not in use and the impact of the failure on the information handling system is low. In another situation, the physical disk 110 can be assigned to a virtual disk, but the virtual disk may not be assigned to any node, such as blade 104 or 106. In this situation, the impact of the failure of the physical disk 110 is also low because no application would be using the virtual disk that the failed physical disk 110 is assigned. In another embodiment, the physical disk 110 can be assigned to virtual disk, which in turn can be assigned to the blade 104. In this situation, if the virtual disk is used by an application as data volume, then a failure of physical disk 112 could lead to loss of data. Therefore, the failure of physical disk 110 in this situation is high.

In an embodiment, the physical disk 110 can be assigned to a virtual disk, which acts as quorum disk or shared storage in a cluster. In this situation, any further failure of a physical disk, such as physical disk 112, on the virtual disk can lead to cluster connectivity loss or cluster data loss. Therefore, the impact of the physical disk 110 when assigned to a virtual disk that is a quorum disk is very high to the information handling system 100.

In an embodiment, a cluster includes multiple servers, such as blades 104 and 106, that can be configured in such a way as to be viewed as a single information handling system. The cluster can be controlled and scheduled by software to have each node or blade set to perform the same task. In an embodiment, the blades 104 and 106 can be configured as a cluster can be connected together through a fast local area network (LAN). In this embodiment, each blade 104 and 106 can run its own instance of an operating system. In most embodiments, the blades 104 and 106 can use the same hardware and the same operating system. However, in some embodiments, the blades 104 and 106 can utilize open source cluster application resources (OSCAR) and the blades can run different operating systems, and/or different hardware.

In an embodiment, a quorum disk can be a storage medium or device on which a configuration database for a cluster is stored. For example, if the physical disks 110 and 112 are utilized as a quorum disk for the cluster formed from the blades 104 and 106, the physical disks can store configuration information for the cluster. In an embodiment, the cluster configuration database, can identify which physical server or servers, such as blade 104 or blade 106, should be active at any given time. In an embodiment, the quorum disk can include a shared block device that allows concurrent read/write access by all blades, such as blade 104 and 106, in a cluster.

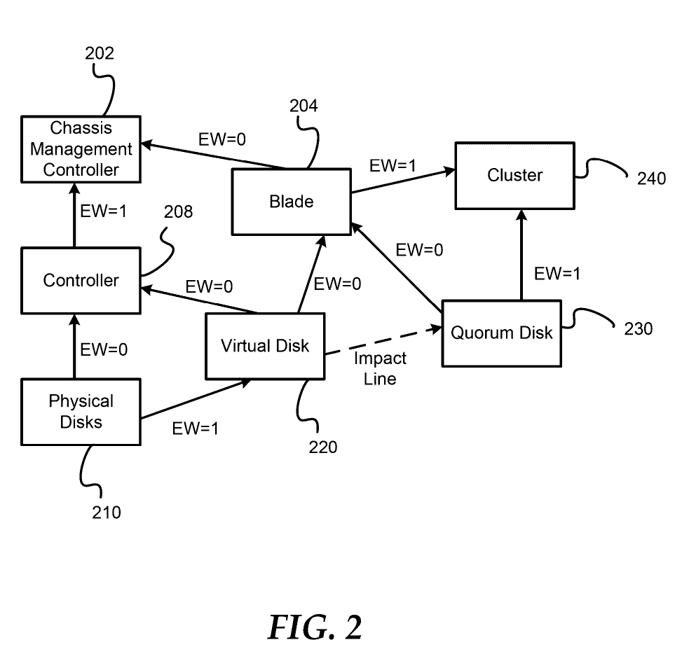

In an embodiment, the impact of the failure of a physical disk configured as a shared storage in a cluster increases as the number of nodes, blades, or servers increase. For example, a physical disk failure in shared storage of cluster with eight nodes is relatively higher as compared to cluster with four nodes. Thus, a critical alert, such as a failure of a physical disk, can have different priorities based on how the component is utilized within the information handling system as will be described in detail with respect to FIGS. 2-5 below.

In an embodiment, the information handling system 100 can designed or configured so that critical servers, such as blades 104 and 106, have sufficient redundancy built into their components to avoid a single point of failure. For example, if there is a critical workload running on blade 104, it is assumed that the fans, power supplies, and the like are configured in redundant mode with sufficient number of fans and power supplies as backup. If the blade 104 is not configured in a redundant mode the impact of an alert coming from this blade may not be able to be determined. Therefore, alerts from non-redundant servers can be grouped into a separate category and monitored closely by an operator of the information handling system 100. For simplicity, this disclosure assumes that all alerts with the same severity level received for the same component can be resolved in any order, such as the latest received alert can be resolved first.

Upon receiving a new alert message, the system management module 107 can compute three different degrees of impact for the alert. For example, the degrees of impact can be component type degree of impact, component degree of impact, and alert degree of impact. In an embodiment, the component type degree of impact can indicate a weightage of the component type in a given topology model according to its impact, the component degree of impact can indicate a weightage of the component in the information handling system 100 according to its impact, and the alert degree of impact can be the severity of the alert. In an embodiment, the severity of the alert can indicate a weightage of the alert among a set of alerts within given component.

In an embodiment, the degrees of impact can be simple numbers computed based on the number of components and type of impact the alert effects. The alerts can be automatically prioritized according to the impact inside the information handling system 100 in response to the alerts being sorted according to the degrees of impact. In an embodiment, a separate model is created for every subsystem, such as storage device, cooling fan, power supply, memory, processor, or the like, and the three degrees of impact computed using those models.

The calculating of the degrees of impact and prioritizing of the alert will be described with respect to the information handling system 100, shown in FIG. 1, including a storage subsystem, such as physical disks 110 and 112, and a cluster of servers, such as blades 104 and 106, utilizing the storage subsystem. When the system management module 107 receives an alert, the system management module can first determine a component type degree of impact for the alert. In an embodiment, the component type degree of impact can be computed based on a direction of impact of an error within a component of the information handling system 100 as shown in FIG. 2.

FIG. 2 shows a diagram illustrating edges of components, such as a chassis management controller 202, a blade 204, a controller 208, a physical disk 210, a virtual disk 220, a quorum disk 230, and a cluster 240, within the information handling system 100. In an embodiment, the direction of an edge is from a physical component to a logical component, from component to its containing component, from components to nodes or blades, and from nodes to cluster. In the diagram of FIG. 2, the arrows between the components indicate the direction of edges. For example, the chassis management controller 202 can have incoming edges from the blade 204 and the controller 208. In an embodiment, the blade 204 can have incoming edges from the virtual disk 220 and the quorum disk 230, and the controller can have incoming edges from the physical disks 210 and the virtual disk 220. In an embodiment, the virtual disk can have an incoming edge from the physical disk 210, and the cluster 240 can have incoming edges from the blade 204 and the quorum disk 230.

The system management module 107 can also determine impact lines for the components within the information handling system 100. In an embodiment, an impact line can be special edges which are created between two unconnected components which are related to each other in some manner. For example, the quorum disk 230 can be a cluster component which needs to be created on a virtual disk accessible to all blades. However, there is no strict containment relationship between the virtual disk 220 and the quorum disk 230. Therefore, the system management module 107 creates an impact line connecting the virtual disk 220 and the quorum disk 230 as shown by the dashed line in FIG. 2.

After the system management module 107 determines the direction of edges for the components, the system management module can determine whether one component actually impacts another component in the information handling system 100. This determination is made depending on whether the component is assigned or contained within another component within the information handling system 100. For example, the edges in FIG. 2 are marked with an edge impact weightage (EW). In this example, if a component impacts another component in the direction of the edge, then the edge arrow is marked with 1, otherwise the edge arrow is marked with 0. One of ordinary skill in the art would recognize that this is only one possible marking scheme, and that any values can be used without diverting from the scope of this disclosure.

The system management module 107 can then compute a component type degree of impact weight (CT). In an embodiment, each component in the information handling system 100 is given an initial component type weight of 1. The system management module 107 then determines the number of incoming edges of impact for a component, and adds the total number of incoming edges (IE) to the component weight type. The system management module 107 then computes, for all components which have incoming edges, the product of edge impact weights (EW) of incoming edge and the weight of the starting node of the incoming edge (WI). In an embodiment the product of the edge impact weights and the weight of the starting node is not calculated for impact lines. The system management module 107 then adds the product (EW*WI) to the initial component type weight (1) and to the total number of incoming edges (IE). The resultant weight is the component type weight (CT). Thus, the component type weight can be calculated using the equation 1 below:

CT=1+IE+EW*WI (EQ. 1)

The values calculated by the system management module 107 can then be stored in a table as shown in Table 1 below:

TABLE 1
Component Type Weights

| | Initial | Incoming Edge | Weighted Edge | Total |
|---|---|---|---|---|
| Component | Weight | Count (IE) | sum (EW*WI) | (CT) |
| Physical Disk | 1 | 0 | 0 | 1 |
| Virtual Disk | 1 | 1 | 1 | 3 |
| Quorum Disk | 1 | 0 | 0 | 1 |
| Controller | 1 | 2 | 0 | 3 |
| Blade | 1 | 2 | 0 | 3 |
| Chassis | 1 | 2 | 3 | 6 |
| Management | | | | |
| Controller | | | | |
| Cluster | 1 | 2 | 4 | 7 |

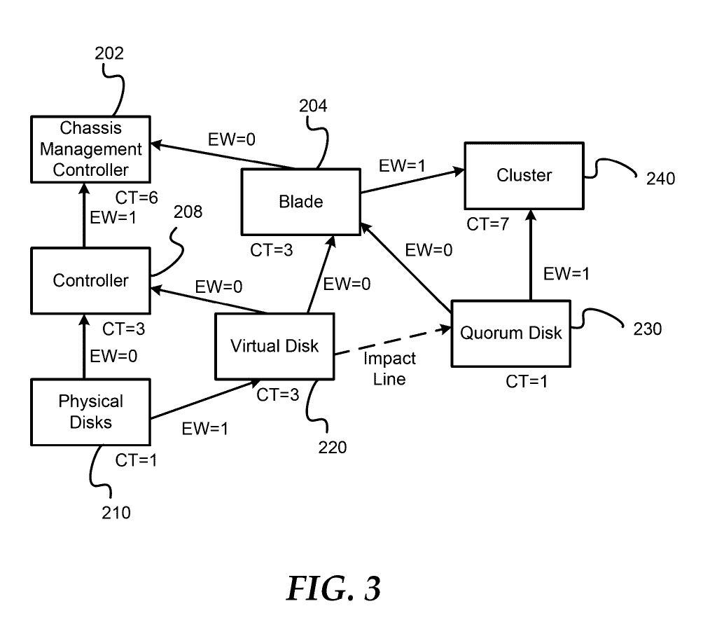

FIG. 3 shows the component type impact weights for each of the components. For example, the cluster 240 has a component type impact weight of 7, and the chassis management controller 202 has a component type impact weight of 6. The blade 204, the controller 208, and the virtual disk 220 each have a component type impact weight of 3, and the physical disk 210 and the quorum disk 230 each have a component type impact weight of 1.

When the system management module 107 sorts the alerts according to component type weights, the highest impacting components are given the highest priority. For example, in table 1 above, alerts related to cluster 240 have the highest priority, alerts related to chassis management controller 202 have the next highest priority, followed by alerts for the blade 204, the controller 208, and the virtual disk 220. The alerts for the physical disk 210 and the quorum disk 230 are given the lowest priority level. In an embodiment, alerts from the cluster 240 or the chassis management controller 202 are alerts that impact only those components. For example, an alert identifying a mismatch between a network interface card (NIC) in the chassis management controller 202 and the chassis management controller firmware is an alert impacting only the chassis management controller. In an embodiment, an alert identifying a failure of the physical disk 210 is considered a physical disk alert and not chassis management controller alert even though the chassis management controller manages the physical disk.

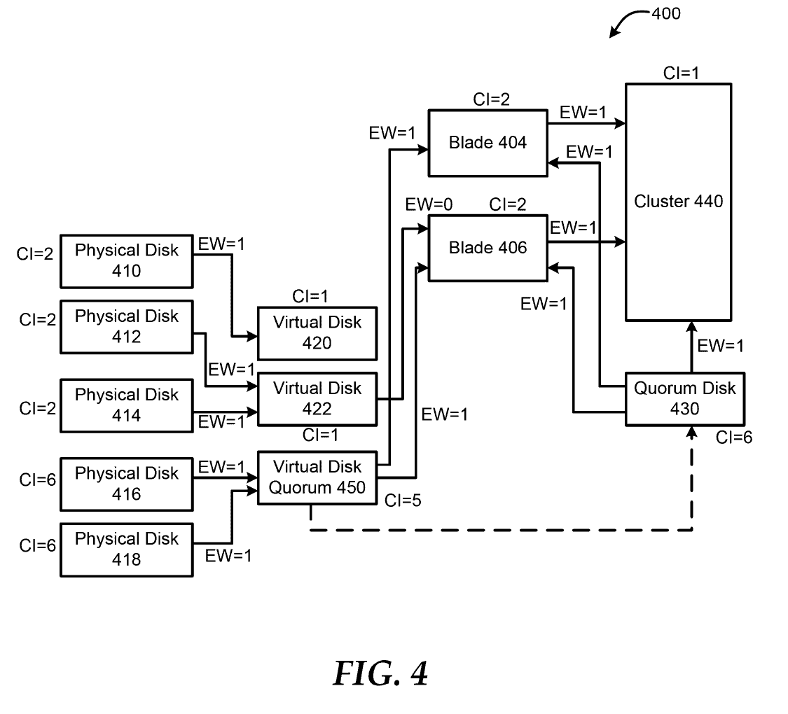

After the system management module 107 determines the component type weight, the system management module can determine the component degree of impact. This degree determines the weightage of the component among all components of a given component type within the information handling system 100. The system management module 107 computed the component degree of impact from the discovered inventory of all cluster, application, and nodes in the information handling system, such as information handling system 400 of FIG. 4.

FIG. 4 shows an information handling system 400 including blades 404 and 406, physical disks 410, 412, 414, 416, and 418 (410-418), virtual disks 420 and 422, a quorum disk 430, a cluster 440, and a virtual disk quorum 450. The system management module, such as system management module 107 of FIG. 1, can first identify the direction of edges in the information handling system 400 as shown by the arrows in FIG. 4. In an embodiment, the discovery of components within the information handling system 400 can be done as part of periodic discovery process. In an embodiment, the more components that are discovered within the information handling system 400, the more accurately alert impacts can be determined.

In an embodiment, the system management module 107 can also discover components within the blades 404 and 406 and blades that are located within the cluster 440. The direction of the edge arrow, in FIG. 4, also shows the direction of impact of an alert. In an embodiment, information handling system 400 includes the cluster 440 that is created from blades 404 and. The physical disks 410-418 are utilized to create the virtual disk 420 and 422, and the virtual disk quorum 450. In an embodiment, the virtual disk 420 is unassigned, the virtual disk 422 is assigned to the blade 406 and virtual disk 450 is used as quorum disk 430 for the cluster 440 and therefore is assigned to blades 404 and 406.

The system management module 107 can then determine an edge impact weightage for each of the components. In an embodiment, if a component impacts another component in the direction of the edge, then edge impact weightage for that component is marked as 1, otherwise edge impact weightage for the component is marked as 0. The system management module 107 assigns an initial edge impact weightage based on whether a component directly affects another component along an edge. For example, each of the physical disks 410-418 impacts the virtual disk to which it is assigned. Therefore, each edge between a physical disk and a virtual disk in FIG. 4 is marked with an edge impact weightage of 1 (EW=1). The blades 404 and 406 affect the cluster 440 to which they are assigned, such that the edge between each blade and the cluster is marked with an edge impact weightage of 1 (EW=1). The quorum disk 430 affects the cluster 440. Therefore, the edge between the quorum disk 430 and the cluster 440 is marked with an edge impact weightage of 1 (EW=1). However, virtual disks 420 and 422, and the virtual quorum disk 450 do not directly impact a blade 404 or 406. Therefore, the edge between each virtual disk and a blade is initial marked 0.

The system management module 107 can then create impact lines between components. As shown in FIG. 4, the quorum disk 430 is component of the cluster 440, and the quorum disk is created on the virtual disk 450 accessible to both blades 406 and 408. There is no strict containment relationship between the virtual disk 450 and the quorum disk 430. However, the system management module 107 creates an impact line, shown as the dotted line in FIG. 4, connecting the virtual disk 450 and the quorum disk 430 to create a relationship. The system management module 107 can then utilize impact line to change the way the edge impact weights described above. In particular, if an impact line exists between two components, then all paths out of the components connected by impact line to same end nodes are selected by the system management module. The system management module 107 can then covert the edge impact weights for the paths that originate from the component at starting end of the impact line, such as the virtual quorum disk 450, to 1.

For example, the system management module 107 can utilize the impact line created from the virtual quorum disk 450 to the quorum disk 430 to identify edge impact weights that should be changed. The system management module 107 can first identify all paths or edges that lead out of either the virtual quorum disk 450 or the quorum disk 430 and that have the same end point. For example, an edge path extends from the virtual quorum disk 450 to the blade 406, and a corresponding edge path extends from the quorum disk 430 to the blade 406. Another edge path extends from the virtual quorum disk 450 to the blade 408, and a corresponding edge path extends from the quorum disk 430 to the blade 408. Another edge path extends from the virtual quorum disk 450 to the blade 406, and then to the cluster 440, a corresponding edge path extends from the quorum disk 430 to the blade 406, and then to the cluster 440, and another corresponding edge path extends from the quorum disk 430 to the cluster 440. An edge path extends from the virtual quorum disk 450 to the blade 408, and then to the cluster 440, a corresponding edge path extends from the quorum disk 430 to the blade 408, and then to the cluster 440, and another corresponding edge path extends from the quorum disk 430 to the cluster 440.

The system management module 107 can then determine which of these paths are unique, such that the path is not contained in another path. For example, the unique paths of the paths described above include: an edge path from the virtual quorum disk 450 to the blade 406, and then to the cluster 440; with a corresponding edge path extends from the quorum disk 430 to the blade 406, and then to the cluster 440; and another corresponding edge path extends from the quorum disk 430 to the cluster 440. Other unique paths include: an edge path extends from the virtual quorum disk 450 to the blade 408, and then to the cluster 440; with a corresponding edge path extends from the quorum disk 430 to the blade 408, and then to the cluster 440; and another corresponding edge path extends from the quorum disk 430 to the cluster 440.

The system management module 107 uses these unique paths to change the edge impact weight of the following paths to 1: virtual quorum disk 450 to blade 404; virtual quorum disk 450 to blade 406; quorum disk 430 to blade 404; and quorum disk 430 to blade 406. After the system management module 107 completes the assigned of edge impact weights, the system management module can component degree of impact (CI). The system management module 107 can assign any component without any outgoing edges a component degree of impact of 1, such as the virtual disk 420, and the cluster 440. All other components are given an initial component degree of impact (CI) weight of 1. The system management module 107 can then calculate a weighted edge value by multiplying the edge impact weight (EW) by the component degree of impact (CI) from which the edge extends. Thus, the component degree of impact can be calculated using the equation 2 below:

CT=1+EW*CI (EQ. 2)

The values calculated by the system management module 107 can then be stored in a table as shown in Table 2 below:

TABLE 2
Component Degree of Impact

| | Initial | Weighted Edge | Total Component |
|---|---|---|---|
| Component | Weight | (EW*WI) | Degree of Impact |
| Physical Disk 410 | 1 | 1 | 2 |
| Physical Disks | 1 | 1 | 2 |
| 412 and 414 | | | |
| Physical Disks | 1 | 5 | 6 |
| 416 and 418 | | | |
| Virtual Disk 420 | 1 | 0 | 1 |
| Virtual Disk 422 | 1 | 0 | 1 |
| Blade 404 | 1 | 1 | 2 |
| Blade 406 | 1 | 1 | 2 |
| Quorum Disk 430 | 1 | 5 | 6 |
| Cluster 440 | 1 | 0 | 1 |
| Virtual Quorum | 1 | 4 | 5 |
| Disk 450 | | | |

Thus, the component degree of impact for the components of information handling system 400 are as follows: virtual disks 402 and 422, and cluster 440 have a degree of impact of 1; physical disks 410-414, and blades 404 and 406 have a degree of impact of 2; virtual quorum disk 450 has a degree of impact of 5; and physical disks 416 and 418, and quorum disk 430 have a degree of impact of 6.

Therefore, when an alert is generated from a component, such as physical disk failure occurs on 410, 412, 414, 416, 418, the corresponding alert degrees of impact are: physical disk assigned to virtual disk 420 has a degree of impact of 2; physical disks 412 and 414 assigned to virtual disk 422 has a degree of impact of 2; and physical disks 416 and 418 assigned to virtual quorum disk 450 has a degree of impact of 6. In an embodiment, the degree of impact is computed from the edge weights. Therefore, the more the edges associated with a component, the higher the degree of impact. For example, if a physical disk failed for a quorum virtual disk of 4 node cluster, then the degree of impact for that physical disk failure alert will be 10 based on the calculation of: 2+2*# of nodes in cluster. In an embodiment, the degree of impact of a virtual disk is same irrespective of whether the virtual disk is assigned to a blade. Thus, a more accurate calculation of degree of impact can be based on the application running on the blade.

The system management module 107 can also determine an alert degree of impact for each received alert message. In an embodiment, the alert degree of impact is based on the severity of the alert. For example, critical alerts, such as physical disk failures, need to be immediately resolved, and warning alerts, such as virtual disk warnings, indicate degraded performance or warning situation and allow some window of time for operators to respond. Additionally, informational alerts either indicate that situation has been resolved or provide certain information about a component, and typically informational alerts do not need any user intervention. The alert degree of impacts are shown in Table 3 below:

TABLE 3
Alert Degree of Impact

| Alert Severity | Degree of Impact |
|---|---|
| Not Recoverable | 100 |
| Critical | 90 |
| Major | 80 |
| Warning | 70 |
| Minor | 60 |
| Information | 50 |
| Debug | 40 |

After the system management module 107 determines or calculates each of the component type degree of impact, the component degree of impact, and the alert degree of impact, the system management module can determine an overall degree of impact for the alert message. The system management module 107 can determine the overall degree of impact by sorting the alert messages according to each of the three degrees of impact, which in turn results in the alert messages being sorted in order of priority.

In an embodiment, some alerts can trigger other alerts in component that are dependent on the first component having an alert. In this situation, the sorting of the alerts can properly prioritize these dependent alerts. For example, a failure of physical disk 414 may trigger a warning or critical alert of virtual disk 422. Similarly, a fan failure may trigger a fan redundancy subsystem warning or critical alert. In these situations, the component type degree of impact is higher if the component type is dependent on another component. Therefore, the virtual disk and fan redundancy subsystem alerts prioritized higher than the respective physical disk and fan failure warnings in the prioritized list of sorted alerts. In an embodiment, a high level component, such as virtual disk 420, fan redundancy, or the like, may mask errors from a lower level component, such as a physical disk 410, a fan, or the like, an operator should review any outstanding alerts at the higher level component before reaching the lower level components. Therefore, alerts associated with higher level components are prioritized above alerts associated with lower level components.

In an embodiment, a physical disk failure, such as physical disk 412, and a resulting virtual disk warning, such as virtual disk 422, in a 4 node cluster is prioritized higher than the same failure and warning in a 2 node cluster as shown in Table 4 below:

TABLE 4
Exemplary Failure Alerts for cluster with different number of nodes

| | | Component | |
|---|---|---|---|
| | Component | Degree of | Alert |
| Scenario | Type | Impact | Severity |
| Virtual Disk acts as Quorum Disk | 3 | 16 | Warning |
| or Shared Storage in 8-node Cluster | | | |
| (VD turned warning as a result of | | | |
| PD critical) | | | |
| Physical disk is assigned to a | 1 | 18 | Critical |
| Virtual Disk, which acts as Quorum | | | |
| Disk or Shared Storage in a 8-node | | | |
| Cluster | | | |
| Physical disk is assigned to a | 1 | 10 | Critical |
| Virtual Disk, which acts as Quorum | | | |
| Disk or Shared Storage in a 4-node | | | |
| Cluster | | | |
| Physical disk is assigned to a | 1 | 2 | Critical |
| Virtual Disk, but it is not assigned | | | |
| to any node | | | |
| Physical disk is assigned to Virtual | 1 | 2 | Critical |
| Disk, assigned to 1 blade | | | |
| Physical disk is not assigned to any | 1 | 1 | Critical |
| Virtual Disk | | | |

Thus, as shown in Table 4 above the more components that a component with an alert is assigned, the higher the overall impact of the alert when the three categories, such at component type weight, component degree of impact, and alert degree of impact, are combined together. Therefore, the alert for that component is prioritized higher in the prioritized list of alerts.

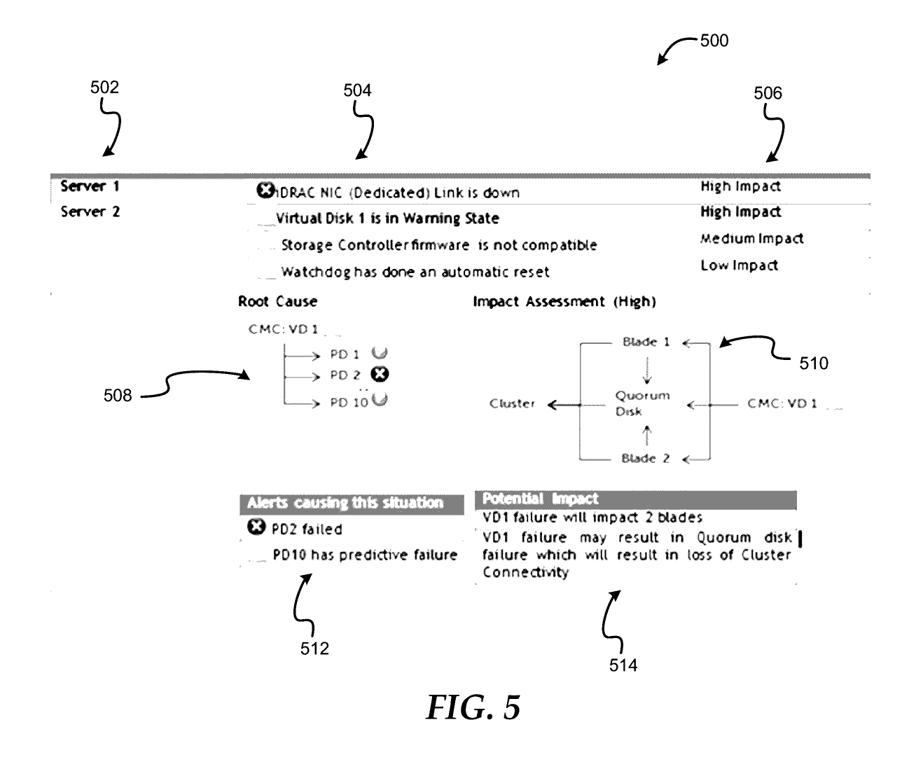

FIG. 5 illustrates an alert graphical user interface (GUI) 500 that can be displayed by the system management module 107 for use by an operator. The alert GUI 500 includes a list of devices 502, an alert description list 504, an alert impact list 506, a root cause 508, impact assessment 510, other alerts 512, and potential impact list 514. In an embodiment, the list of devices 502 identifies each of the devices that have an alert. In an embodiment, the servers listed in the list of devices 502 can be the blades 104 and 106 of FIG. 1.

The alert description list 504 can include a short description of the alert, such as dedicated link is down, and can include an icon to provide the operator with a quick glance to know the type of alert. For example, a red circle with an ‘X’ can indicate a failure of a component, and a yellow triangle with an ‘!’ can indicate a warning. In an embodiment, the alert impact list 506 can describe the level of impact for the alert, such as high impact, medium impact, or low impact.

In response to the operator selecting an alert, the alert GUI 500 can expand to display the root cause 508 of the alert, the impact assessment 510, the other alerts 512 that cause the selected alert, and the potential impact list 514. In an embodiment, the root cause 508 can show that a virtual disk of a server includes multiple physical disks, and show a status icon for each of the physical disks. For example, the status icon for the first physical disk is a green circle with the check mark to indicate that the first physical disk is working properly. However, the status icon for the second physical disk is a red circle with an ‘X’ to indicate that the second physical disk has failed. Thus, the root cause portion 508 can provide an operator with view of the devices that might need to be repaired or replaced to resolve the alert.

The impact assessment portion 510 can show devices in the information handling system that may be affected by the alert for a particular device. For example, the impact assessment portion 510 of alert GUI 500 indicates that the virtual disk is assigned to two blades and a quorum disk, and that the blades and quorum disk are assigned to a cluster. Therefore, the alert for the virtual disk can potential cause alerts in the blades, quorum disk, and cluster in the information handling system. The other alerts portion 512 of the alert GUI 500 can list other alerts that effect the selected alert from the alert description list 504. In an embodiment, the potential impact list 514 can describe the possible impacts of the selected alert if that alert is not resolved.

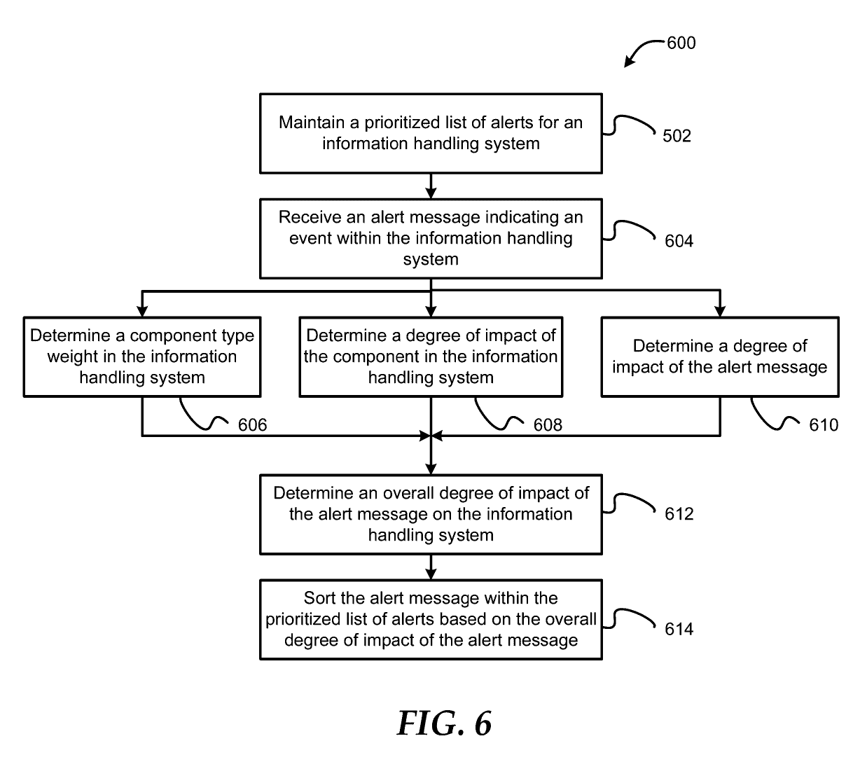

FIG. 6 illustrates a flow diagram of a method 600 for assessing degree of impact of alerts in an information handling system. At block 602, a prioritized list of alerts for the information handling system is maintained by a system management module. In an embodiment, the prioritized list of alerts is stored on a memory coupled to the system management module. An alert indicating an event within the information handling system is received at block 604. In an embodiment, the event is a failure of a component within the information handing system. At block 606, a component type weight in the information handling system is determined. In an embodiment, the component type is identified in the alert message. A degree of impact of the component in the information handling system is determined at block 608. At block 610, a degree of impact of the alert message is determined. In an embodiment, the degree of impact of the alert message indicates a severity of the alert message for the component. In an embodiment, the determination of blocks 606, 608, and 610 can performed at substantially the same time as shown in FIG. 6, can be performed one after another, or the like. Used herein, at substantially the same can indicate that the operations performed in each of the blocks overlap in time, such as either completely or partially overlap.

At block 612, an overall degree of impact of the alert message on the information handling system is determined. In an embodiment, the overall degree of impact is based on the combination of the weightage of a component type in the information handling system, the degree of impact of the component in the information handling system, and the degree of impact of the alert message. The alert message is sorted within the prioritized list of alerts based on the overall degree of impact of the alert message as compared to an overall degree of impact of each of the alert messages in the prioritized list of alerts at block 614.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
maintaining, by a system management module, a prioritized list of alerts for an information handling system;
receiving, at the system management module, an alert indicating an event within the information handling system;
determining an overall degree of impact of the alert message on the information handling system; and
sorting the alert message within the prioritized list of alerts based on the overall degree of impact of the alert message as compared to an overall degree of impact of each of the alert messages in the prioritized list of alerts.

2. The method of claim 1, wherein determining the overall degree of impact of the alert message on the information handling system comprises:
determining a component type weight in the information handling system, the component type being identified in the alert message.

3. The method of claim 2, wherein determining the overall degree of impact of the alert message on the information handling system further comprises:
determining a degree of impact of the component in the information handling system.

4. The method of claim 3, wherein determining the overall degree of impact of the alert message on the information handling system further comprises:
determining a degree of impact of the alert message, wherein the degree of impact of the alert message indicates a severity of the alert message for the component.

5. The method of claim 1, wherein the event is a failure of a component within the information handing system.

6. The method of claim 5, wherein the overall degree of impact includes an impact of the failure of the component on an operation of the information handling system.

7. The method of claim 1, wherein the prioritized list of alerts is stored on a memory coupled to the system management module.

8. An information handling system comprising:
a plurality of components;
a memory to store a prioritized list of alerts issued in the information handling system; and
a system management module to communicate with the components and with the memory, the system management module to maintain the prioritized list of alerts, to receive an alert indicating an event within the information handling system, to determine an overall degree of impact of the alert message on the information handling system, and to sort the alert message within the prioritized list of alerts based on the overall degree of impact of the alert message as compared to an overall degree of impact of each of the alert messages in the prioritized list of alerts.

9. The information handling system of claim 8, wherein the system management module determines the overall degree of impact of the alert message on the information handling system based on a component type weight in the information handling system, the component type being identified in the alert message.

10. The information handling system of claim 9, wherein the system management module determines the overall degree of impact of the alert message on the information handling system further based on a degree of impact of the component in the information handling system.

11. The information handling system of claim 10, wherein the system management module determines the overall degree of impact of the alert message on the information handling system further based on a degree of impact of the alert message, wherein the degree of impact of the alert message indicates a severity of the alert message for the component.

12. The information handling system of claim 8, the system management module further to display the prioritized list of alerts on an alert graphical user interface.

13. The information handling system of claim 12, the system management module further to receive a selection of an alert within the prioritized list of alert displayed on the alert graphical user interface, and to provide information about the selected alert on the graphical user interface.

14. The information handling system of claim 8, wherein the event is a failure of a component within the information handing system.

15. The information handling system of claim 14, wherein the overall degree of impact includes an impact of the failure of the component on an operation of the information handling system.

16. A method comprising:
maintaining, by a system management module, a prioritized list of alerts for an information handling system;
receiving, at the system management module, an alert indicating an event within the information handling system;
determining an overall degree of impact of the alert message on the information handling system;
sorting the alert message within the prioritized list of alerts based on the overall degree of impact of the alert message as compared to an overall degree of impact of each of the alert messages in the prioritized list of alerts; and
displaying the prioritized list of alerts in an alert graphical user interface.

17. The method of claim 16, wherein determining the overall degree of impact of the alert message on the information handling system comprises:
determining a component type weight in the information handling system, the component type being identified in the alert message.

18. The method of claim 17, wherein determining the overall degree of impact of the alert message on the information handling system further comprises:
determining a degree of impact of the component in the information handling system.

19. The method of claim 18, wherein determining the overall degree of impact of the alert message on the information handling system further comprises:
determining a degree of impact of the alert message, wherein the degree of impact of the alert message indicates a severity of the alert message for the component.

20. The method of claim 16, further comprising:
receiving a selection of an alert within the prioritized list of alert displayed on the alert graphical user interface; and
providing information about the selected alert on the graphical user interface.
